(19) United States
(12) Patent Application Publication
(10) Pub. No.: US 2023/0215450 A1
(43) Pub. Date: Jul. 6, 2023

(54) AUTOMATIC NOISE GATING

(71) Applicant: Tymphany Worldwide Enterprises Limited, Taipei City (TW)

(72) Inventor: Ryan Meng-Wei LU, Grand Cayman (KY)

(21) Appl. No.: 18/093,574

(22) Filed: Jan. 5, 2023

Related U.S. Application Data
(60) Provisional application No. 63/297,126, filed on Jan. 6, 2022.

(51) Int. Cl. G10L 21/0208; G10L 25/84

(52) U.S. Cl. CPC G10L 21/0208; G10L 25/84

(57) ABSTRACT

An audio processing system for automatically noise gating an audio signal. The audio processing system comprises a voice activity detector configured to identify one or more segments of the audio signal not representative of speech; a level detector configured to determine at least one noise level associated with the one or more segments of the audio signal identified as not representative of speech; and a noise gate configured to noise gate the audio signal using a variable noise gate threshold that is automatically set based on the at least one determined noise level.

### TECHNICAL FIELD

This application claims the benefit of priority of U.S. Provisional Application No. 63/297,126 filed on Jan. 6, 2022, the entire contents of which are hereby incorporated by reference.

The present disclosure relates generally to systems and methods for removing noise from audio signals using a noise gate.

### BACKGROUND

A noise gate is a voice processing component that can be used in certain applications to remove unwanted noise from audio signals. Noise gates may be used, for example, in microphone recording post-processing or in real-time audio signal processing.

In its simplest form a noise gate mutes or attenuates an audio signal or a component of an audio signal. The noise gate may be associated with a threshold such that if an audio signal level rises above the threshold, the audio signal (e.g., a main audio signal) is allowed to pass. On the other hand, if the audio signal level falls below the threshold, no signal (or less signal) is allowed to pass. The threshold may be set above the level of unwanted noise, but below the expected level of a main audio signal, such that the unwanted noise is attenuated or blocked by the noise gate. More complex noise gates may employ more than one threshold value. For example, a noise gate may employ an “open threshold” and a “close threshold”. The open threshold defines the level the audio signal must exceed to go from a “closed” state, in which the audio signal is attenuated, to an “open” state, in which the audio signal is allowed to pass through the noise gate unattenuated. The close threshold defines the level the audio signal must fall below to go from the open state to the closed state. The open threshold is typically set to a higher level than the close threshold to provide a bias for remaining in the current state, either open or closed.

A user may adjust the noise gate threshold value(s) in order to optimize the noise gate performance so that noise is effectively attenuated without attenuating the desired audio signals. Setting the noise gate threshold too high may result in loss of desired information in the audio signal (e.g. vocal or instrument sound), whereas setting the noise gate threshold too low may allow too much unwanted noise to remain in the audio signal. It is difficult for a user to adjust the noise gate threshold value. The background noise level may also vary within the audio signal, which makes setting the noise gate threshold value(s) challenging.

There is therefore a need for methods and systems for automatically setting a noise gate threshold level so that it is adapted to a current noise level in the audio signal.

### SUMMARY

According to some embodiments of the present disclosure, there is provided an audio processing system for automatically noise gating an audio signal. The audio processing system comprises a voice activity detector configured to identify one or more segments of the audio signal not representative of speech; a level detector configured to determine at least one noise level associated with the one or more segments of the audio signal identified as not representative of speech; and a noise gate configured to noise gate the audio signal using a variable noise gate threshold that is automatically set based on the at least one determined noise level.

### BRIEF DESCRIPTION OF DRAWINGS

FIG. 1 is a diagrammatic representation of an exemplary audio processing system for automatically noise gating an audio signal consistent with some embodiments of the present disclosure.

FIG. 2 represents a method for automatically noise gating an audio signal consistent with some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

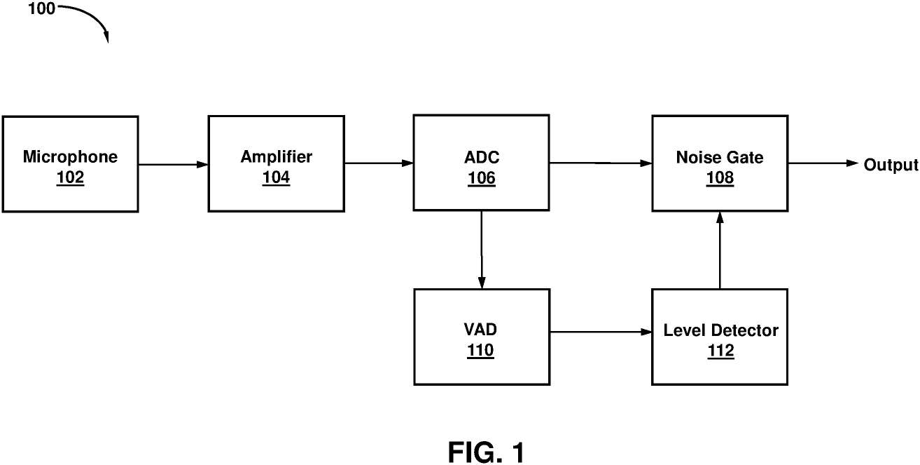

Referring to FIG. 1, audio processing system 100 may include a microphone 102 for sensing sound and outputting an audio signal representative of the sensed sound. Microphone 102 comprises a transducer that converts sensed sound into an analog electrical signal. Microphone 102 therefore generates an analog audio signal. The sounds sensed by microphone 102 may contain speech sounds, and the audio signal output by microphone 102 may therefore contain segments that are representative of speech. Conversely, the audio signal output by microphone 102 may include segments representative of sounds other than speech. Unwanted noise may exist both in segments representative of speech and in segments representative of sounds other than speech.

Audio processing system 100 may also include an amplifier 104 configured to receive the analog audio signal from microphone 102. Amplifier 104 amplifies the analog audio signal output by microphone 102 and therefore provides gain to the analog audio signal. Amplifier 104 may include a pre-amplifier, and may, for example, include a programmable gain amplifier (PGA) or a gain block. Amplifier 104 may amplify the analog audio signal to match the range of the analog audio signal to the range of analog-to-digital convertor (ADC) 106 (discussed in further detail below). For example, amplifier 104 may amplify the analog audio signal to match or substantially match the range of the analog audio signal to the range of analog-to-digital convertor (ADC) 106 discussed in further detail below.

Audio processing system 100 may include ADC 106. ADC 106 is configured to receive the analog audio signal, optionally amplified by amplifier 104 if present, and convert the analog audio signal to a digital audio signal. ADC 106 may include any sort of ADC capable of converting the analog audio signal to a digital audio signal. For example, ADC 106 may include, without limitation, a flash or direct ADC, a semi-flash ADC, an SAR ACD, a sigma-delta ACD or a pipelined ACD.

In some embodiments, microphone 102, amplifier 104 and ADC 106 may be incorporated into a single device, such as a MEMS (micro-electromechanical system) microphone device. In other embodiments, microphone 102, amplifier 104 and ADC 106 may be included in multiple discrete devices.

Audio processing system 100 of the FIG. 1 example further includes a noise gate 108 configured to noise gate the audio signal. Noise gating is an audio processing technique that involves selectively attenuating an audio signal depending on the intensity of the audio signal relative to one or more noise gate threshold values. For example, noise gate 108 may mute or attenuate, either fully or partially, the audio signal if the intensity of the audio signal is below a noise gate threshold value. Conversely, if the intensity of the digital audio signal is above the noise gate threshold value the noise gate may allow the audio signal to pass through the noise gate substantially unattenuated.

Noise gate 108 may employ a single noise gate threshold value to noise gate the audio signal, or it may employ more than one noise gate threshold value to noise gate the audio signal. For example, if noise gate 108 employs a single noise gate threshold then it may mute or attenuate the audio signal when the intensity of the digital audio signal is below the noise gate threshold and may allow the audio signal to pass through substantially unattenuated when the audio signal intensity is above the noise gate threshold. Alternatively, noise gate 108 may use an “open threshold” and a “close threshold”. The open threshold is the level the audio signal intensity must reach or exceed before noise gate 108 transitions from a “closed” state, in which it at least partially attenuates the audio signal, to an “open” state, in which the signal is allowed to pass through noise gate 108 substantially unattenuated. The close threshold is the level the audio signal must fall below or reduce to before noise gate 108 transitions from its open state to its closed state. The open threshold value is typically set to a higher intensity level than the close threshold value and therefore provides a bias or inertia for remaining in the current state, either open or closed.

As used herein, the term “audio signal intensity” generally refers to the amplitude or volume of the audio signal, or how loud the audio signal is. Audio volume defines the intensity of soundwaves and is typically measured in decibels (dB). The noise gate threshold values may therefore be set to a volume or intensity measured or expressed in dB.

One or more of the noise gate threshold values may be variable. For example, one or more of the noise gate threshold values may be adaptable to a current expected noise level, as explained in further detail below. As such, the term “value”, where used in relation to the noise gate threshold values, is not to be construed as necessarily meaning a fixed or unchanging value. Instead, the noise gate threshold values employed by noise gate 108 may vary over time or may be dynamically set or adjusted rather than taking a pre-determined or fixed value. For example, a noise gate threshold value employed by the noise gate may be varied in the temporal domain of the audio signal so that it takes one value at a first time in the audio signal and another value at a second time in the audio signal different from the first time. If the audio signal processing is performed in real-time, for example in a public address (PA) system or a musical instrument (e.g. guitar) amplifier, then the noise gate threshold value may be varied or be dynamically adjusted as the audio signal is processed by audio processing system 100. Alternatively, a noise gate threshold value may take the same value throughout the audio signal (i.e. the noise gate may use an unchanging threshold value for noise gating the entire audio signal) but may be automatically adjusted or set before operating on the audio signal.

Still referring to FIG. 1, audio processing system 100 further comprises a voice activity detector (VAD) 110 and a level detector 112. The adjustable noise gate threshold(s) may be automatically set or adjusted based on processing of the audio signal by VAD 110 and level detector 112. VAD 110 is configured to receive the audio signal output by ADC 106. VAD 110 performs voice activity detection (sometimes referred to as speech activity detection or speech detection) on the audio signal to identify segments of the audio signal that are representative of (i.e. contain audio signals representing) speech and/or segments of the audio signal that are not representative of (i.e. do not contain audio signals representing) speech.

VAD 110 may process the audio signal using a voice activity detection algorithm to identify or detect segments of the audio signal that are representative of and/or not representative of speech. Each segment of the audio signal may comprise one or more audio frames of the audio signal. Various voice activity detection algorithms may be employed in the context of the present disclosure. In order to determine whether a segment of the audio signal is or is not representative of speech, a voice activity detection algorithm may perform one or more calculations relative to one or more features of the audio signal segment (e.g., frequency patterns, etc.). The algorithm may then apply one or more classification rules to the one or more calculated features to classify the segment as either representative of speech or not representative of speech. For example, a classification rule may involve determining whether a particular feature meets a particular requirement, such as whether the feature meets a threshold value or is within a certain range. If the VAD 110 determines that a particular audio segment includes speech (e.g., speech = 1; non-speech = 0), then the level detector 112 operation may be suspended relative that particular audio segment. On the other hand, if the VAD 110 determines that a another audio segment does not include speech (e.g., speech = 0; non-speech = 1), then the level detector 112 operation may be activated relative the another audio segment, and a noise level associated with the another audio segment may be detected.

Level detector 112 is configured to process one or more segments of the audio signal to determine a noise level associated with each of the processed segments. The noise level refers to an intensity or volume associated with noise in the audio signal and may therefore be expressed or measured in dB. Level detector 112 may employ a level detection algorithm to determine a noise level in each processed segment of the audio signal. The level detection algorithm may process segments of the audio signal to determine the noise levels of the audio segments in various ways. For example, the level detection algorithm may perform one or more calculations relative to one or more features of the audio signal segment and may determine the noise level based on calculated values associated with the one or more features. For example, the level detection algorithm may determine the noise level of an audio signal segment based on the average signal intensity of the audio signal segment. Alternatively, the level detection algorithm may determine the noise level of an audio signal segment based on the maximum or peak signal intensity of the audio signal segment. Yet another possibility is that the level detection algorithm determines the noise level of an audio signal segment such that a given proportion of the audio signal segment has an intensity below the noise level. More complex level detection methods are also possible that are based on more complex statistical features of the audio signal segment.

Level detector 112 may be configured to receive one or more segments of the audio signal determined to be not representative of speech by VAD 110 and to determine at least one noise level associated with each of the one or more segments. For example, VAD 110 may send only those audio signal segments that it determines are not representative of speech to level detector 112. VAD 110 may therefore not pass audio signal segments that it determines are representative of speech to level detector 112. The audio signal segments that are not representative of speech are typically more representative of unwanted background noise. As such, the noise levels of such segments determined by level detector provide a reliable indication of the actual unwanted background noise levels. VAD 110 provides a reliable and efficient means for filtering the audio signal such that only those segments of the audio signal that are not representative of speech are sent to level detector 112 for level detection.

At least one noise gate threshold used by noise gate 108 may be automatically set or adjusted based on one or more of the noise levels determined by level detector 112. Level detector 112 may therefore be said to set, adjust or update the value of a noise gate threshold used by noise gate 108 based on one or more of the determined noise levels of the one or more audio signal segments. The level detector 112 may, therefore, send one or more controls signal to noise gate 108 that cause the noise gate threshold to be automatically set or adjusted based on one or more of the noise levels determined by level detector 112. The adjustable noise gate threshold may, for example, be set to substantially match the determined noise level(s), or may be set to a value mathematically related to or calculated based on the determined noise level(s).

In some embodiments, the adjustable noise gate threshold(s) is set based on a determined noise level of a most recent segment of the audio signal identified as not representative of speech. For example, each time an audio signal segment that is not representative of speech is identified by VAD 110, level detector 112 may process that audio signal segment to determine a noise level associated with that audio signal segment. The value of the adjustable noise gate threshold may then be updated based on the determined noise level of that segment. Subsequent segments of the audio signal may then be noise gated by noise gate 108 using the updated noise gate threshold until another segment of the audio signal is identified as not representative of speech by VAD 110, at which point level detector 112 will determine a noise level of that segment and the adjustable noise gate threshold will once more be updated based on the newly determined noise level. This approach may ensure that the noise gate threshold used by noise gate 108 is automatically adapted to the actual background noise levels in the audio signal. In other words, the noise gate threshold is automatically set or adapted based on a variable expected noise level or value, which is determined from or based on the noise levels determined by level detector 112.

Audio processing system 100 may process the audio signal in real-time, as the audio signal is output by microphone 102. The noise gate(s) may therefore be adjusted in real time, or on-the-fly. Alternatively, audio processing system 100 may be used to post-process an audio signal.

The various components of audio processing system 100 may be implemented using hardware and/or software. For example, noise gate 108, VAD 110, and level detector 112 may be implemented using any suitable processing hardware or logic devices including one or more dedicated processing units, CPUs, application-specific integrated circuits (ASICs), field-programmable gate arrays (FPGAs), or various other types of processors or processing units. The various units need not be separate and distinct entities, and may, for example, be implemented using the same instances of hardware and/or software. For example, VAD 110, level detector 112 and noise gate 108 may be implemented as instructions stored on one or more computer-readable storage media that are executed by one or more processors or processing units to provide the required signal processing functionality.

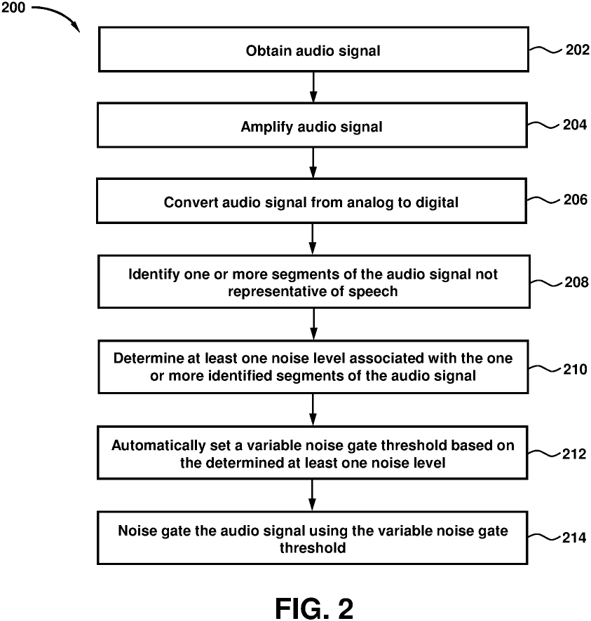

Referring to FIG. 2, the present disclosure also provides a method 200 for automatically noise gating an audio signal. Method 200 generally corresponds to the actions performed by system 100. As such, the same or similar considerations apply, and the principles outlined in the context of system 100 generally apply to the corresponding steps of method 200. However, the steps of method 200 are not necessarily tied to the same functional units as recited in relation to system 100 and it is the method steps themselves rather than the components of the system that are generally defined by method 200.

Method 200 may include step 202 of obtaining an audio signal. The audio signal may be obtained using a microphone such as microphone 102 of system 100, and the audio signal may be based on output generated by the microphone. In other words, step 202 may comprise using a microphone to sense sound and generate an audio signal representative of the sensed sound. Alternatively, step 202 may involve simply receiving an audio signal. The audio signal may be received from a microphone or from another source, such as a computer memory. Method 200 need not therefore involve the step of actually generating the audio signal. The obtained audio signal may be an analog audio signal, such as that output by a microphone, or may be a digital audio signal.

Method 200 may optionally comprise step 204 of amplifying the obtained audio signal. For example, if the audio signal obtained in step 202 is an analog audio signal then an amplifier such as amplifier 104 of system 100 may amplify the analog audio signal to provide gain to the analog audio signal. The audio signal may be amplified to match or substantially match the range of the analog audio signal to the range of the ADC used to convert the analog audio signal to a digital audio signal in step 206 discussed below.

Method 200 may optionally comprise step 206 of converting the analog audio signal, optionally amplified in step 204, into a digital audio signal. Step 206 may be performed using an ADC such as ADC 106 of system 100.

Steps 204 and 206 need not be performed if, for example, the audio signal obtained in step 202 is already a digital audio signal.

Method 200 may comprise step 208 of identifying one or more segments of the audio signal that are not representative of speech. Step 208 may be performed using a voice activity detector (VAD), such as VAD 110 of system 100. Step 208 may involve processing the audio signal using a voice activity detection algorithm to identify or detect segments of the audio signal that are representative and/or not representative of speech, as described in relation to VAD 110 of system 100.

Method 200 may further comprise step 210 of determining at least one noise level associated with the one or more identified segments of the audio signal. Step 210 may be performed using a level detector, such as level detector 112 of system 100. Step 210 may involve processing one or more of the identified segments of the audio signal to determine a noise level associated with each of the processed segments. Step 210 may be performed using a level detection algorithm, as described in relation to level detector 112 of system 100.

Method 200 may further comprise step 212 of automatically setting or adjusting at least one variable noise gate threshold based on the at least one noise level determined in step 210, as described above in relation to system 100. For example, the variable noise gate threshold may be automatically set based on the noise level determined in step 210 of one or more most recent segments of the audio signal identified as not representative of speech in step 208.

Method 200 may further comprise step 214 of noise gating the audio signal using the variable noise gate threshold. Step 214 may be performed using a noise gate, such as noise gate 108 of system 100. The noise gating process may be performed as described above in relation to noise gate 108 of system 100.

The system and method of the invention provide for automatic adjustment of a noise gate threshold so that the noise gate threshold is adapted to a current expected noise level. The present disclosure therefore provides improved systems and methods for noise gating audio signals.

The steps of the example methods set forth herein are not necessarily required to be performed in the order described, and the order of the steps of such methods should be understood to be merely example. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

The described embodiments are not mutually exclusive, and elements, components, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

As used in the present disclosure, the word “exemplary” is used herein to mean serving as an example, instance, or illustration. Any aspect or design described herein as “exemplary” is not necessarily to be construed as preferred or advantageous over other aspects or designs. Rather, use of the word is intended to present concepts in a concrete fashion.

As used in the present disclosure, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated in order to explain the nature of described embodiments may be made by those skilled in the art without departing from the scope. Accordingly, the following claims embrace all such alternatives, modifications and variations that fall within the terms of the claims.

What is claimed is:

1. An audio processing system for automatically noise gating an audio signal, comprising:
a voice activity detector configured to identify one or more segments of the audio signal not representative of speech;
a level detector configured to determine at least one noise level associated with the one or more segments of the audio signal identified as not representative of speech; and
a noise gate configured to noise gate the audio signal using a variable noise gate threshold that is automatically set based on the at least one determined noise level.

2. The audio processing system of claim 1, wherein the voice activity detector is configured to send to the level detector only the segments of the audio signal identified as not representative of speech.

3. The audio processing system of claim 1, wherein each of the segments of the audio signal comprises one or more audio frames of the audio signal.

4. The audio processing system of claim 1, wherein the noise gate threshold is set based on a variable expected noise value.

5. The audio processing system of claim 1, wherein the noise gate threshold is set based on the determined noise level of a most recent segment of the audio signal identified as not representative of speech.

6. The audio processing system of claim 5, wherein the level detector is configured to automatically set the noise gate threshold to approximately match the determined noise level of the most recent segment of the audio signal identified as representative of speech.

7. The audio processing system of claim 1, wherein the audio processing system includes a microphone configured to output the audio signal in response to sensed sounds.

8. The audio processing system of claim 7, wherein the microphone outputs the audio signal as an analog audio signal, and wherein the audio processing system further comprises an analog-to-digital convertor configured to convert the analog audio signal to a digital audio signal.

9. A method for automatically noise gating an audio signal, comprising:
identifying, using a voice activity detector, one or more segments of the audio signal not representative of speech;
determining at least one noise level associated with the one or more identified segments of the audio signal;
automatically setting a variable noise gate threshold based on the determined at least one noise level; and
noise gating the audio signal using the variable noise gate threshold.

10. The method of claim 9, wherein the at least one noise level is determined using a level detector.

11. The method of claim 10, wherein only segments of the audio signal identified by the voice activity detector as not representative of speech are sent to the level detector.

12. The method of claim 9, wherein each segment of the audio signal comprises one or more audio frames of the audio signal.

13. The method of claim 9, wherein the noise gate threshold is automatically set to a variable expected noise value.

14. The method of claim 9, wherein the noise gate threshold is automatically set based on the determined noise level of a most recent segment of the audio signal identified as not representative of speech.

15. The method of claim 14, wherein the noise gate threshold is automatically set to approximately match the determined noise level of the most recent segment of the audio signal identified as not representative of speech.

16. The method of claim 9, wherein the audio signal is based on output generated by a microphone.

17. The method of claim 16, wherein the microphone outputs the audio signal as an analog audio signal, and wherein the method further comprises converting the analog audio signal to a digital audio signal.
